(19) United States
(12) Patent Application Publication
(10) Pub. No.: US 2025/0364235 A1
(43) Pub. Date: Nov. 27, 2025

(54) A METHOD FOR MULTIPLE REACTION MONITORING USING A MASS SPECTROMETRY DEVICE

(71) Applicant: Roche Diagnostics Operations, Inc., Indianapolis, IN (US)

(72) Inventors: Robert Lang, Muenchen (DE); Indranil Mitra, Benediktbeuern (DE)

(21) Appl. No.: 18/873,724

(22) PCT Filed: Jun. 9, 2023
(86) PCT No.: PCT/EP2023/065435

§ 371 Date: Dec. 10, 2024

(30) Foreign Application Priority Data
Jun. 10, 2022 (EP) 22178342.6

(51) Int. Cl. H01J 49/00

(52) U.S. Cl. CPC H01J 49/0009

(57) ABSTRACT

A method for multiple reaction monitoring using a mass spectrometry device (106) is proposed. The method comprises the following steps: i) (128) measuring, by using the mass spectrometry device (106), multiple reaction monitoring transitions of quantifier and qualifier of both an internal standard and an analyte using staggered-multiple reaction monitoring, wherein the staggered-multiple reaction monitoring comprises at least three multiple reaction monitoring channel groups, wherein one of the multiple reaction monitoring channel groups measure at respective theoretical m/z values of the quantifier and qualifier of both the internal standard and the analyte and the two other multiple reaction monitoring channel groups measure at respective m/z values shifted to higher and lower values by a predefined level; ii) (130) comparing, for at least two groups, at least two of the quantifier/qualifier ratios of the multiple reaction monitoring transitions of the internal standard with a reference value from a database (126) by using at least one processing device (120), wherein the comparison comprises determining a deviation between the quantifier/qualifier ratios and the reference value; iii) (132) determining from the analyte and the internal standard measured multiple reaction monitoring transitions a measurement result by using the processing device (120), if the deviation for at least one of the quantifier/qualifier ratios is within at least one predefined tolerance range, otherwise rejecting (136) the measured multiple reaction monitoring transitions.

### TECHNICAL FIELD

This is a disclosure of a method and a device for multiple reaction monitoring using mass spectrometry techniques, specifically liquid chromatography and mass spectrometry.

### BACKGROUND ART

Mass spectrometry (MS) systems are widely used for the analysis of biological samples, due to their high resolution and ability to analyze relatively small sample volumes, relative to certain other analytical methods. As part of an analytical workflow, mass spectrometry systems can be coupled to liquid chromatography (LC) separation systems. Complex samples such as body fluids can be injected into the LC separation system and separated into sequentially eluted components, which are then analyzed on the MS system. The combination of LC separation and selective MS-based analysis allows a wide variety of different samples to be quantitatively analyzed.

Instability of mass axis, i.e. drifts in mass accuracy and resolution, may be caused by changes in one or more of temperature and humidity, MS contamination, and drift in the mass axis over longer times between mass axis calibrations. This may hamper LC-MS methods by decreasing sensitivity due to lower ion transmission and detection of the target analyte and decreasing selectivity due to relatively higher ion transmission and detection of sample matrix components with similar physiochemical properties as the analyte, i.e. similar LC retention time and Multiple Reaction Monitoring (MRM) transition. A common strategy to sustain sensitivity of LC-MS methods against mass axis instability is to decrease the MS resolution. However, this strategy may decrease the method selectivity by compromising its ability to distinguish signal from sample matrix components from the analyte signal.

WO 2021/140178 A1 describes a system for analyzing a biological sample including a separation unit configured to separate a component from the biological sample, an ionization unit configured to generate a plurality of ions from the component, an adjustable mass-selective filtering element, a detector configured to detect ions that pass through the mass-selective filtering element, and a controller connected to the mass-selective filtering element and to the detector. The controller is configured so that during operation of the system it adjusts the mass-selective filtering element and activates the detector to measure at least three different ion signals corresponding to the plurality of ions, and determines a mass axis shift of the system based on the at least three different ion signals.

WO 2021/239692 A1 describes a computer implemented method for calibrating a customer mass spectrometry instrument for quantifier-qualifier-ratio check. The method comprises the following steps: a) at least one manufacturer-site standardization, wherein a set of samples of a subject and a set of calibrator samples are measured in multiple replicates on a plurality of mass spectrometry instruments, wherein each measurement comprises multiple reaction monitoring with quantifier and qualifier transition for analyte and internal standard, wherein at least three adjustment factors are determined from the measurements of the set of samples of a subject and the set of calibrator samples, wherein a first adjustment factor; depends on a difference between analyte and internal standard, wherein a second adjustment factor depends on a difference between samples of a subject and calibrator samples for analyte quantifier-qualifier-ratio, wherein a third adjustment factor depends on a difference between samples of a subject and calibrator samples for the internal standard quantifier-qualifier-ratio; b) at least one transfer step, wherein the adjustment factors are electronically transferred to a customer mass spectrometry instrument; c) at least one customer-site calibration, wherein the customer-site calibration comprises at least one calibration measurement, wherein a set of calibrator samples is measured on the customer mass spectrometry instrument and quantifier-qualifier-ratios are determined therefrom, wherein target values for quantifier-qualifier-ratios for analyte and for internal standard are set by applying the adjustment factors on the determined quantifier-qualifier-ratios.

### Problem to be Solved

It is therefore an objective of the present invention to provide a method and a device for multiple transition monitoring, which avoid the above-described disadvantages of known methods and devices. In particular, the method and the device shall improve sustaining sensitivity and selectivity of LC-MS methods against mass axis instability.

### SUMMARY

This problem is solved by a method and a device for multiple transition monitoring, having the features of the independent claims. Preferred embodiments of the invention, which may be realized in an isolated way or in any arbitrary combination, are disclosed in the dependent claims.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

In a first aspect of the present invention, a method for multiple transition monitoring using a mass spectrometry device is disclosed.

The method comprises the following steps which, as an example, may be performed in the given order. It shall be noted, however, that a different order is also possible. Further, it is also possible to perform one or more of the method steps once or repeatedly. Further, it is possible to perform two or more of the method steps simultaneously or in a timely overlapping fashion. The method may comprise further method steps which are not listed.

The method comprises the following steps:
i) measuring, by using the mass spectrometry device, multiple reaction monitoring transitions of quantifier and qualifier of both an internal standard and an analyte using staggered-multiple reaction monitoring, wherein the staggered-multiple reaction monitoring comprises at least three multiple reaction monitoring channel groups, wherein one of the multiple reaction monitoring channel groups measure at respective theoretical m/z values of the quantifier and qualifier of both the internal standard and the analyte and the two other multiple reaction monitoring channel groups measure at respective m/z values shifted to higher and lower values by a predefined level;
ii) comparing at least two quantifier/qualifier ratios of the multiple reaction monitoring transitions of the internal standard with a reference value from a database by using at least one processing device, wherein the comparison comprises determining a deviation between the quantifier/qualifier ratios and the reference value;
iii) determining from the analyte and the internal standard measured multiple reaction monitoring transitions a measurement result by using the processing device, if the deviation for at least one of the quantifier/qualifier ratios is within at least one predefined tolerance range, otherwise rejecting the measured multiple reaction monitoring transition.

As stated above, the method may use staggered-multiple reaction monitoring. This may allow sustaining sensitivity and selectivity of LC-MS methods against mass axis instability.

The method may be computer-implemented. The term “computer implemented method” as used herein is a broad term and is to be given its ordinary and customary meaning to a person of ordinary skill in the art and is not to be limited to a special or customized meaning. The term specifically may refer, without limitation, to a method involving at least one computer and/or at least one computer network. The computer and/or computer network may comprise at least one processor which is configured for performing at least one of the method steps of the method according to the present invention. Preferably each of the method steps is performed by the computer and/or computer network. The method may be performed completely automatically, specifically without user interaction. The terms “automatically” and “automated” as used herein are broad terms and are to be given their ordinary and customary meaning to a person of ordinary skill in the art and is not to be limited to a special or customized meaning. The terms specifically may refer, without limitation, to a process which is performed completely by means of at least one computer and/or computer network and/or machine, in particular without manual action and/or interaction with a user.

The term “multiple reaction monitoring” (MRM), also denoted multiple transition monitoring, as used herein is a broad term and is to be given its ordinary and customary meaning to a person of ordinary skill in the art and is not to be limited to a special or customized meaning. The term specifically may refer, without limitation, to a method used in mass spectrometry, specifically in tandem mass spectrometry, in which multiple product ions from one or more precursor ions are monitored. As used herein, the term “monitoring” is a broad term and is to be given its ordinary and customary meaning to a person of ordinary skill in the art and is not to be limited to a special or customized meaning. The term specifically may refer, without limitation, to determining and/or detecting of multiple product ions.

The term “mass spectrometry” as used herein is a broad term and is to be given its ordinary and customary meaning to a person of ordinary skill in the art and is not to be limited to a special or customized meaning. The term specifically may refer, without limitation, to an analytical technique for determining a mass-to-charge ratio of ions. The mass spectrometry may be performed using at least one mass spectrometry device. As used herein, the term “mass spectrometry device”, also denoted “mass analyzer”, is a broad term and is to be given its ordinary and customary meaning to a person of ordinary skill in the art and is not to be limited to a special or customized meaning. The term specifically may refer, without limitation, to an analyzer configured for detecting at least one analyte based on mass-to-charge ratio.

The mass spectrometry device may be or may comprise at least one quadrupole analyzer. As used herein, the term “quadrupole mass analyzer” is a broad term and is to be given its ordinary and customary meaning to a person of ordinary skill in the art and is not to be limited to a special or customized meaning. The term specifically may refer, without limitation, to a mass analyzer comprising at least one quadrupole as mass filter. The quadrupole mass analyzer may comprise a plurality of quadrupoles. For example, the quadrupole mass analyzer may be a triple quadrupole mass spectrometer. For example, the mass spectrometry device may comprise an ionization source, a skimmer, and three quadrupolar stages Q1, Q2 and Q3 and a detector. Each of the quadrupolar stages Q1, Q2 and Q3 comprising a quadrupole.

As used herein, the term “mass filter” is a broad term and is to be given its ordinary and customary meaning to a person of ordinary skill in the art and is not to be limited to a special or customized meaning. The term specifically may refer, without limitation, to a device configured for selecting ions injected to the mass filter according to their mass-to-charge ratio m/z. The mass filter may comprise two pairs of electrodes. The electrodes may be rod-shaped, in particular cylindrical. In ideal case, the electrodes may be hyperbolic. The electrodes may be designed identical. The electrodes may be arranged in parallel extending along a common axis, e.g. a z axis. The quadrupole mass analyzer may comprise at least one power supply circuitry configured for applying at least one direct current (DC) voltage and at least one alternating current (AC) voltage between the two pairs of electrodes of the mass filter. The power supply circuitry may be configured for holding each opposing electrode pair at identical potential. The power supply circuitry may be configured for changing polarity of voltage of the electrode pairs periodically such that stable trajectories are only possible for ions within a certain mass-to-charge ratio m/z. Trajectories of ions within the mass filter can be described by the Mathieu differential equations. For measuring ions of different m/z values DC and AC voltage may be changed in time such that ions with different m/z values can be transmitted to a detector of the mass spectrometry device.

The mass spectrometry device may further comprise at least one ionization source. As used herein, the term “ionization source”, also denoted as “ion source” or “ionizer”, is a broad term and is to be given its ordinary and customary meaning to a person of ordinary skill in the art and is not to be limited to a special or customized meaning. The term specifically may refer, without limitation, to a device configured for generating molecular ions, e.g. from a gas, liquid, or solid sample. The ionization source may be or may comprise at least one source selected from the group consisting of: at least one gas phase ionization source such as at least one electron ionization (EI) source or at least one chemical ionization (CI) source; at least one desorption ionization source such as at least one plasma desorption (PD) source, at least one fast atom bombardment (FAB) source, at least one secondary ion mass spectrometry (SIMS) source, at least one laser desorption (LD) source, and at least one matrix assisted laser desorption ionization (MALDI) source; at least one spray ionization source such as at least one thermospray (TSP) source, at least one atmospheric pressure chemical ionization (APCI) source, at least one electrospray (ESI), and at least one atmospheric pressure ionization (API) source.

The mass spectrometry device may comprise at least one detector. As used herein, the term “detector” is a broad term and is to be given its ordinary and customary meaning to a person of ordinary skill in the art and is not to be limited to a special or customized meaning. The term specifically may refer, without limitation, to an apparatus configured for detecting incoming ions. The detector may be configured for detecting charged particles. The detector may be or may comprise at least one electron multiplier. The mass spectrometry device, in particular the detector and/or at least one processing unit of the mass spectrometry device, may be configured to determining at least one mass spectrum of the detected ions. As used herein, the term “mass spectrum” is a broad term and is to be given its ordinary and customary meaning to a person of ordinary skill in the art and is not to be limited to a special or customized meaning. The term specifically may refer, without limitation, to a two dimensional representation of signal intensity vs the mass-to-charge ratio (m/z), wherein the signal intensity corresponds to abundance of the respective ion. The mass spectrum may be a pixelated image. For determining resulting intensities of pixels of the mass spectrum, signals detected with the detector within a certain m/z range may be integrated. The analyte in the sample may be identified by the processing unit. Specifically, the processing unit may be configured for correlating known masses to the identified masses or through a characteristic fragmentation pattern.

The mass spectrometry device may be or may comprise a liquid chromatography mass spectrometry device. The mass spectrometry device may be connected to and/or may comprise at least one liquid chromatograph, also denoted as liquid chromatography (LC) device. The liquid chromatograph may be used as sample preparation for the mass spectrometry device. Other embodiments of sample preparation may be possible, such as at least one gas chromatograph. As used herein, the term “liquid chromatography mass spectrometry device” is a broad term and is to be given its ordinary and customary meaning to a person of ordinary skill in the art and is not to be limited to a special or customized meaning. The term specifically may refer, without limitation, to a combination of liquid chromatography with mass spectrometry. The mass spectrometry device may comprise at least one liquid chromatograph. The liquid chromatography mass spectrometry device may be or may comprise at least one high performance liquid chromatography (HPLC) device or at least one micro liquid chromatography (μLC) device. The liquid chromatography mass spectrometry device may comprise a liquid chromatography (LC) device and a mass spectrometry (MS) device, in the present case the mass filter, wherein the LC device and the mass filter are coupled via at least one interface. The interface coupling the LC device and the MS device may comprise the ionization source configured for generating of molecular ions and for transferring of the molecular ions into the gas phase. The interface may further comprise at least one ion mobility module arranged between the ionization source and the mass filter. For example, the ion mobility module may be a high-field asymmetric waveform ion mobility spectrometry (FAIMS) module.

As used herein, the term “liquid chromatography (LC) device” is a broad term and is to be given its ordinary and customary meaning to a person of ordinary skill in the art and is not to be limited to a special or customized meaning. The term specifically may refer, without limitation, to an analytical module configured to separate one or more analytes of interest of a sample from other components of the sample for detection of one or more analytes with the mass spectrometry device. The LC device may comprise at least one LC column. For example, the LC device may be a single-column LC device or a multi-column LC device having a plurality of LC columns. The LC column may have a stationary phase through which a mobile phase is pumped in order to separate and/or elute and/or transfer the analytes of interest. The liquid chromatography mass spectrometry device may further comprise a sample preparation station for the automated pre-treatment and preparation of samples each comprising at least one analyte of interest.

The mass spectrometry device may be configured for performing an end-to-end workflow (also denoted as sample measurement workflow) in which a sample is injected into an inlet of the liquid chromatography column, the sample is separated into components on the column, and individual components are eluted from the column. The eluted components are directed into the mass spectrometer where they are ionized and analyzed. The mass spectrometer measures ion fragmentation patterns associated with each of the components. Each ion fragmentation pattern consists of one or more peaks corresponding to ion fragments with particular m/z ratios. The pattern of peaks for a particular analyte (e.g., the m/z ratios and intensities of the peaks) effectively function as a “fingerprint” for the analyte. Due to the complex nature of the fragmentation pattern, a wide variety of components can be identified and quantified based on such measurements. Typically, identification is performed by comparing a measured ion fragmentation pattern with reference information (e.g., previously measured or simulated ion fragmentation patterns for known components). Identification of particular components can also be performed based on the time interval between initial introduction of the sample (e.g., injection into the inlet of the LC-MS system) and elution of a component from the LC column, or the time interval between initial introduction of the sample and measurement of a component ion fragmentation pattern in the mass spectrometer. Certain components may migrate through the LC column at particular rates, and the elapsed time interval can be used as an indicator of the component's identity. As with ion fragmentation patterns, the elapsed time interval can be compared with reference information (e.g., previously measured migration and/or measurement times for known components) to determine the component's identity.

The mass spectrometry device may be operated in a random access mode. As used herein, the term “random access mode” is a broad term and is to be given its ordinary and customary meaning to a person of ordinary skill in the art and is not to be limited to a special or customized meaning. The term specifically may refer, without limitation, to an operation mode in which samples are randomly and continuously loaded. The random access mode may comprise completely automatically loading the samples. The random access mode may further comprise performing fully and/or completely automatically a sample measurement workflow on the mass spectrometry device. This may allow significantly increasing throughput.

As used herein, the term “sample” is a broad term and is to be given its ordinary and customary meaning to a person of ordinary skill in the art and is not to be limited to a special or customized meaning. The term specifically may refer, without limitation, to an arbitrary test sample such as a biological sample. The mass spectrometry device may be configured for measuring a wide variety of biological samples. Examples of such samples include, but are not limited to, physiological fluid, including blood, serum, plasma, urine, sweat, saliva, ocular lens fluid, cerebral spinal fluid, milk, ascites fluid, mucous, synovial fluid, peritoneal fluid, amniotic fluid, lymph fluid, interstitial fluid, cerebrospinal fluid, tissue, cells or the like. The sample may comprise one or more analytes of interest, also denoted as targeted analyte. The sample may be used directly as obtained from the respective source or may be subject of a pretreatment and/or sample preparation workflow. For example, the sample may be pretreated by adding an internal standard and/or by being diluted with another solution and/or by having being mixed with reagents or the like. For example, analytes of interest may be vitamin D, drugs of abuse, therapeutic drugs, hormones, and metabolites in general. For further details with respect to the sample, reference is made e.g. to EP 3 425 369 A1, the full disclosure is included herewith by reference. Other analytes of interest are possible.

The term “internal standard” (ISTD), as used herein is a broad term and is to be given its ordinary and customary meaning to a person of ordinary skill in the art and is not to be limited to a special or customized meaning. The term specifically may refer, without limitation, to a known amount of a substance. The internal standard may exhibit similar properties as the analyte of interest when subjected to a workflow using the mass spectrometry device. The workflow may comprise any pre-treatment, enrichment and actual detection step, as described above. For example, the internal standard may be an isotopically labeled variant (comprising e.g. 2H, 13C, or 15N etc. label) of the analyte of interest.

The term “quantifier”, also denoted as “quantifier ion” as used herein is a broad term and is to be given its ordinary and customary meaning to a person of ordinary skill in the art and is not to be limited to a special or customized meaning. The term specifically may refer, without limitation, to a transition used for quantification of the analyte. The quantifier may be the most abundant ion. The term “qualifier”, also denoted as “qualifier ion” as used herein is a broad term and is to be given its ordinary and customary meaning to a person of ordinary skill in the art and is not to be limited to a special or customized meaning. The term specifically may refer, without limitation, to a further transition which to confirm the measurement. The term “quantifier/qualifier ratio” as used herein is a broad term and is to be given its ordinary and customary meaning to a person of ordinary skill in the art and is not to be limited to a special or customized meaning. The term specifically may refer, without limitation, to an signal intensity ratio or peak area ratio of the quantifier and qualifier.

The term “staggered-multiple reaction monitoring” (S-MRM), as used herein is a broad term and is to be given its ordinary and customary meaning to a person of ordinary skill in the art and is not to be limited to a special or customized meaning. The term specifically may refer, without limitation, to multiple reaction monitoring using a set of staggered m/z values, e.g. a theoretical m/z value and m/z values shifted to higher and lower values by a predefined level. The predefined level may be specified as half of a maximum expected drift of a mass axis for a relevant m/z range. Additional measurement at other levels may be possible, too.

The staggered-multiple reaction monitoring comprises at least three multiple reaction monitoring channel groups. The term “multiple reaction monitoring channel group”, as used herein, is a broad term and is to be given its ordinary and customary meaning to a person of ordinary skill in the art and is not to be limited to a special or customized meaning. The term specifically may refer, without limitation, to one or more of MRM transitions measured at Q1 and Q3 using the same m/z value. One of the multiple reaction monitoring channel groups measures at respective theoretical m/z values of the quantifier and qualifier of both the internal standard and the analyte and the two other multiple reaction monitoring channel groups measure at respective m/z values shifted to higher and lower values by a predefined level. For example, the S-MRM may use MS resolution(s) at Q1 and Q3 that are optimized for the targeted analyte for all MRM transitions. A first MRM transition set may be measured comprising of the quantifier and qualifier MRM transitions for both analyte and internal standard at their respective targeted m/z values. In addition, a second MRM transition set may be measured which is shifted to a higher m/z value at Q1 and Q3 and a third MRM transition set may be measured which is shifted to a lower m/z value at Q1 and Q3. Hence, a total of six MRM transitions for the targeted analyte and a total of six MRM transitions for the internal standard may be measured. For example, the method may comprise the following measurements:

| No | Compound | Q1 | Q3 |
|---|---|---|---|
| 1 | Analyte | Target m/z | Target m/z |
| 2 | Analyte | Target m/z + 0.2 Da | Target m/z + 0.2 Da |
| 3 | Analyte | Target m/z − 0.2 Da | Target m/z − 0.2 Da |
| 4 | ISTD | Target m/z | Target m/z |
| 5 | ISTD | Target m/z + 0.2 Da | Target m/z + 0.2 Da |
| 6 | ISTD | Target m/z − 0.2 Da | Target m/z − 0.2 Da |

Step ii) comprises comparing at least two quantifier/qualifier ratios of the multiple reaction monitoring transitions of the internal standard with a reference value from a database by using at least one processing device.

The term “processing device” as used herein is a broad term and is to be given its ordinary and customary meaning to a person of ordinary skill in the art and is not to be limited to a special or customized meaning. The term specifically may refer, without limitation, to an arbitrary logic circuitry configured for performing basic operations of a computer or system, and/or, generally, to a device which is configured for performing calculations or logic operations. The processing device may be configured for processing basic instructions that drive the computer or system. As an example, the processing device may comprise at least one arithmetic logic unit (ALU), at least one floating-point unit (FPU), such as a math co-processor or a numeric co-processor, a plurality of registers, specifically registers configured for supplying operands to the ALU and storing results of operations, and a memory, such as an L1 and L2 cache memory. The processing device may be a multi-core processor. The processing device may be or may comprise a central processing unit (CPU). Additionally or alternatively, the processing device may be or may comprise a microprocessor, thus specifically the processor's elements may be contained in one single integrated circuitry (IC) chip. Additionally or alternatively, the processing device may be or may comprise one or more application-specific integrated circuits (ASICs) and/or one or more field-programmable gate arrays (FPGAs) and/or one or more tensor processing unit (TPU) and/or one or more chip, such as a dedicated machine learning optimized chip, or the like. The processing device may be configured, such as by software programming, for performing one or more evaluation operations. The processing device may be configured for performing the named method step(s). Thus, as an example, the processing device may comprise a software code stored thereon comprising a number of computer instructions. The processing device may provide one or more hardware elements for performing one or more of the indicated operations and/or may provide one or more processors with software running thereon for performing one or more of the method steps.

The term “database” as used herein is a broad term and is to be given its ordinary and customary meaning to a person of ordinary skill in the art and is not to be limited to a special or customized meaning. The term specifically may refer, without limitation, to an organized collection of data, generally stored and accessed electronically from a computer or computer system. The database may comprise or may be comprised by a data storage device. The database may comprise at least one data base management system, comprising a software running on a computer or computer system, the software allowing for interaction with one or more of a user, an application or the database itself, such as in order to capture and analyze the data contained in the database. The database management system may further encompass facilities to administer the database. The database, containing the data, may, thus, be comprised by a data base system which, besides the data, comprises one or more associated applications.

The database may be part of the processing device or may be external to the processing device. The processing device may comprise at least one communication interface. The communication interface may be configured for transmitting data at least one of from or to or within the processing device. The term “communication interface” as used herein is a broad term and is to be given its ordinary and customary meaning to a person of ordinary skill in the art and is not to be limited to a special or customized meaning. The term specifically may refer, without limitation, to an item or element forming a boundary configured for transferring information. In particular, the communication interface may be configured for transferring information from a computational device, e.g. a computer, such as to send or output information, e.g. onto another device. Additionally or alternatively, the communication interface may be configured for transferring information onto a computational device, e.g. onto a computer, such as to receive information. The communication interface may specifically provide means for transferring or exchanging information. In particular, the communication interface may provide a data transfer connection, e.g. Bluetooth, NFC, inductive coupling or the like. As an example, the communication interface may be or may comprise at least one port comprising one or more of a network or internet port, a USB-port and a disk drive. The communication interface may comprise at least one web interface.

The processing device and/or the database may be at least partially cloud-based. The term “cloud-based” as used herein is a broad term and is to be given its ordinary and customary meaning to a person of ordinary skill in the art and is not to be limited to a special or customized meaning. The term specifically may refer, without limitation, to an outsourcing of the processing device or of parts of the processing device to at least partially interconnected external devices, specifically computers or computer networks having larger computing power and/or data storage volume. The external devices may be arbitrarily spatially distributed. The external devices may vary over time, specifically on demand. The external devices may be interconnected by using the internet. The external devices may each comprise at least one communication interface.

The term “reference value” as used herein is a broad term and is to be given its ordinary and customary meaning to a person of ordinary skill in the art and is not to be limited to a special or customized meaning. The term specifically may refer, without limitation, to a pre-defined and/or pre-measured quantifier/qualifier ratio of the internal standard at a target m/z. The database may comprise at least one information of the group consisting of an analyte ID, a sample matrix ID, an instrument ID, a method or assay ID, an average quantifier/qualifier ratio of the internal standard. From one or more of this information the processing device may determine the reference value.

Step ii) may comprise comparing all of the quantifier/qualifier ratio of the multiple reaction monitoring transitions of the internal standard measured in step i) with the reference value.

Additionally or alternatively, in step ii) a selection may be performed. Step ii) may comprise selecting two quantifier/qualifier ratios of the multiple reaction monitoring transitions of the internal standard depending on signal intensities of the multiple reaction monitoring transitions of the internal standard quantifier. Step ii) may comprise comparing the selected quantifier/qualifier ratios of the multiple reaction monitoring transitions of the internal standard with the reference value. Step ii) may comprise comparing signal intensities of the multiple reaction monitoring transitions of the internal standard quantifier. For example, step ii) may comprise comparing signal intensities of the three MRM transitions of the internal standard quantifier. The comparison of the signal intensities may be performed by executing a software algorithm.

In the case where the mass axis is stable (i.e. minimal or no drift), the multiple reaction monitoring channel group measuring using the respective m/z values for the targeted analyte and ISTD will produce the highest signal intensity. In the case where the mass axis drifts significantly to higher or lower m/z values, one of the other multiple reaction monitoring channel groups will produce the highest signal intensity.

Step ii) may comprise rejecting the multiple reaction monitoring transition with the lowest signal intensity. For example, step ii) may comprise selecting two of three internal standard MRM transitions with highest signal intensity and rejecting the MRM transition with the lowest signal intensity.

The comparison of the quantifier/qualifier ratios of the multiple reaction monitoring transitions of the internal standard comprises determining a deviation between the quantifier/qualifier ratios and the reference value. Step ii) may comprise comparing the quantifier/qualifier ratios of the remaining multiple reaction monitoring transitions of the internal standard with the reference value. The comparison may comprise at least one mathematical operation.

Depending on the result of the comparison in step ii), in step iii) different actions may be performed. If the deviation for at least one of the quantifier/qualifier ratios is within at least one predefined tolerance range, step iii) comprises determining from the analyte and the internal standard measured multiple reaction monitoring transitions a measurement result by using the processing device. The predefined tolerance range may be ±15%, preferably ±10%, more preferably ±5% from the reference value. The determining of the measurement result may be performed by executing a software algorithm. The measurement result may be or may comprise at least one quantitative information, e.g. a value, about the analyte in the sample. The measurement result may be the final patient result. The measurement result may further comprise a quality information about the stability of the mass axis depending on the determined deviation, e.g. a flag.

Otherwise, i.e. in case the deviation for none of the quantifier/qualifier ratios is within the predefined tolerance range, step iii) comprises rejecting the measured multiple reaction monitoring transitions. Step iii) may further comprise flagging the data as outlier. Step iii) may comprise checking the quantifier/qualifier ratio of the two remaining MRM transitions of the internal standard and rejecting any that deviate by more than at least one predefined tolerance range from the reference value.

For example, if the deviation from only one of the quantifier/qualifier ratios of the remaining multiple reaction monitoring transitions is within the predefined tolerance range, step iii) comprises determining the measurement result from the multiple reaction monitoring transitions of the analyte and the internal standard of the multiple reaction monitoring channel group corresponding to said quantifier/qualifier ratio. For example, the final patient result may be calculated by analyte_{MRM}/ISTD_{MRM} using the single MRM transition set of analyte and internal standard of the multiple reaction monitoring channel group fulfilling the condition. Step iii) may comprise rejecting any multiple reaction monitoring channel group that deviates by more than the predefined tolerance range from the reference value.

For example, if the deviations for both quantifier/qualifier ratios of the remaining multiple reaction monitoring transitions are within the predefined tolerance range, step iii) may comprise determining the measurement result from the analyte and the internal standard using a sum of the remaining multiple reaction monitoring transitions. For determining of the measurement result the multiple reaction monitoring transitions of the analyte and the internal standard of the multiple reaction monitoring channel groups corresponding to said quantifier/qualifier ratios fulfilling the condition may be used. For example, the analyte and internal standard transitions of the monitoring channel groups fulfilling the condition may be denoted as FirstAnalyte_{MRM}, Second Analyte_{MRM}, FirstISTD_{MRM} and SecondISTD_{MRM} The sum may be determined by

$$\frac{{FirstAnalyte}_{MRM} + {SecondAnalyte}_{MRM}}{{FirstISTD}_{MRM} + {SecondISTD}_{MRM}} .$$

The summing of the two staggered MRM transition sets can result in higher sensitivity. Step iii) may comprise rejecting any multiple reaction monitoring channel group that deviates by more than the predefined tolerance range from the reference value.

For example, in case no selected was performed and if the deviations for each of the quantifier/qualifier ratios of the multiple reaction monitoring transitions are within the predefined tolerance range, step iii) may comprise determining the measurement result from the analyte and the internal standard using a sum of the multiple reaction monitoring transitions. Thus, for determining of the measurement result the multiple reaction monitoring transitions of the analyte and the internal standard of all multiple reaction monitoring channel groups may be used. For example, the analyte and internal standard transitions of the monitoring channel groups may be denoted as FirstAnalyte_{MRM}, SecondAnalyte_{MRM}, ThirdAnalyte_{MRM}, FirstISTD_{MRM} and SecondISTD_{MRM}, ThirdISTD_{MRM} The sum may be determined by

$$\frac{{FirstAnalyte}_{MRM} + {SecondAnalyte}_{MRM} + {ThirdAnalyte}_{MRM}}{{FirstISTD}_{MRM} + {SecondISTD}_{MRM} + {ThirdISTD}_{MRM}} .$$

The summing of the three staggered MRM transition sets can result in higher sensitivity.

The method steps i) to iii) may be performed by using at least one computer. Specifically, controlling and performing of the measurement in step i) may be performed fully automatically. Moreover, data acquisition and evaluation in steps ii) and iii) may be performed fully automatically. The method specifically may fully or partially be computer-implemented, specifically on a computer, such as a processor.

In a further aspect, a computer program including computer-executable instructions for performing the method according to any one of the embodiments as described herein is disclosed, specifically method steps i) to iii), when the program is executed on a computer or computer network, specifically a processing device. Specifically, the computer program may be stored on a computer-readable data carrier and/or on a computer-readable storage medium.

As used herein, the terms “computer-readable data carrier” and “computer-readable storage medium” specifically may refer to non-transitory data storage means, such as a hardware storage medium having stored thereon computer-executable instructions. The computer-readable data carrier or storage medium specifically may be or may comprise a storage medium such as a random-access memory (RAM) and/or a read-only memory (ROM).

Thus, specifically, one, more than one or even all of method steps i) to iii) as indicated above may be performed by using a computer or a computer network, preferably by using a computer program.

Further disclosed and proposed herein is a computer program product having program code means, in order to perform the method according to the present invention in one or more of the embodiments enclosed herein when the program is executed on a computer or computer network. Specifically, the program code means may be stored on a computer-readable data carrier and/or on a computer-readable storage medium.

Further disclosed and proposed herein is a data carrier having a data structure stored thereon, which, after loading into a computer or computer network, such as into a working memory or main memory of the computer or computer network, may execute the method according to one or more of the embodiments disclosed herein.

Further disclosed and proposed herein is a non-transient computer-readable medium including instructions that, when executed by one or more processors, cause the one or more processors to perform the method according to one or more of the embodiments disclosed herein.

Further disclosed and proposed herein is a computer program product with program code means stored on a machine-readable carrier, in order to perform the method according to one or more of the embodiments disclosed herein, when the program is executed on a computer or computer network. As used herein, a computer program product refers to the program as a tradable product. The product may generally exist in an arbitrary format, such as in a paper format, or on a computer-readable data carrier and/or on a computer-readable storage medium. Specifically, the computer program product may be distributed over a data network.

Finally, disclosed and proposed herein is a modulated data signal which contains instructions readable by a computer system or computer network, for performing the method according to one or more of the embodiments disclosed herein.

Referring to the computer-implemented aspects of the invention, one or more of the method steps or even all of the method steps of the method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

Specifically, further disclosed herein are:
a computer or computer network comprising at least one processor, wherein the processor is adapted to perform the method according to one of the embodiments described in this description,
a computer loadable data structure that is adapted to perform the method according to one of the embodiments described in this description while the data structure is being executed on a computer,
a computer program, wherein the computer program is adapted to perform the method according to one of the embodiments described in this description while the program is being executed on a computer,
a computer program comprising program means for performing the method according to one of the embodiments described in this description while the computer program is being executed on a computer or on a computer network,
a computer program comprising program means according to the preceding embodiment, wherein the program means are stored on a storage medium readable to a computer,
a storage medium, wherein a data structure is stored on the storage medium and wherein the data structure is adapted to perform the method according to one of the embodiments described in this description after having been loaded into a main and/or working storage of a computer or of a computer network, and
a computer program product having program code means, wherein the program code means can be stored or are stored on a storage medium, for performing the method according to one of the embodiments described in this description, if the program code means are executed on a computer or on a computer network.

In a further aspect of the present invention, a system for multiple transition monitoring of at least one analyte in a sample, is disclosed.

The system comprises:
at least one mass spectrometer device configured for measuring multiple reaction monitoring transitions of quantifier and qualifier of both an internal standard and an analyte using staggered-multiple reaction monitoring, wherein the staggered-multiple reaction monitoring comprises at least three multiple reaction monitoring channel groups, wherein one of the multiple reaction monitoring channel groups measure at respective theoretical m/z values of the quantifier and qualifier of both the internal standard and the analyte and the two other multiple reaction monitoring channel groups measure at respective m/z values shifted to higher and lower values by a predefined level;
at least one database configured for storing at least one reference value;
at least one processing device configured for comparing at least two quantifier/qualifier ratio of the multiple reaction monitoring transitions of the internal standard with the reference value from the database, the comparison comprises determining a deviation between the quantifier/qualifier ratios and the reference value, wherein the processing device is configured for determining from the analyte and the internal standard measured multiple reaction monitoring transitions a measurement result, if the deviation is within at least one predefined tolerance range, and otherwise for rejecting the measured multiple reaction monitoring transitions.

The system may be configured for performing a method for multiple reaction monitoring according to the present invention. Thus, with respect to definitions and embodiments, reference is made to the description of the method above or as described on more detail below.

Summarizing and without excluding further possible embodiments, the following embodiments may be envisaged:
Embodiment 1. A method for multiple reaction monitoring using a mass spectrometry device, the method comprises the following steps:
   i) measuring, by using the mass spectrometry device, multiple reaction monitoring transitions of quantifier and qualifier of both an internal standard and an analyte using staggered-multiple reaction monitoring, wherein the staggered-multiple reaction monitoring comprises at least three multiple reaction monitoring channel groups, wherein one of the multiple reaction monitoring channel groups measure at respective theoretical m/z values of the quantifier and qualifier of both the internal standard and the analyte and the two other multiple reaction monitoring channel groups measure at respective m/z values shifted to higher and lower values by a predefined level;
   ii) comparing at least two of the quantifier/qualifier ratios of the multiple reaction monitoring transitions of the internal standard with a reference value from a database by using at least one processing device, wherein the comparison comprises determining a deviation between the quantifier/qualifier ratios and the reference value;
   iii) determining from the analyte and the internal standard measured multiple reaction monitoring transitions a measurement result by using the processing device, if the deviation for at least one of the quantifier/qualifier ratios is within at least one predefined tolerance range, otherwise rejecting the measured multiple reaction monitoring transitions.
Embodiment 2. The method according to the preceding embodiment, wherein the predefined level is specified as half of a maximum expected drift of a mass axis for a relevant m/z range.
Embodiment 3. The method according to any one of the preceding embodiments, wherein the predefined tolerance range is ±15%, preferably ±10%, more preferably ±5% from the reference value.
Embodiment 4. The method according to any one of the preceding embodiments, wherein step ii) comprises selecting two quantifier/qualifier ratios of the multiple reaction monitoring transitions of the internal standard depending on signal intensities of the multiple reaction monitoring transitions of the internal standard quantifier.
Embodiment 5. The method according to the preceding embodiment, wherein step ii) comprises comparing the selected quantifier/qualifier ratios of the multiple reaction monitoring transitions of the internal standard with the reference value.
Embodiment 6. The method according to any one of the two preceding embodiments, wherein step ii) comprises comparing signal intensities of the multiple reaction monitoring transitions of the internal standard quantifier, wherein step ii) comprises rejecting the multiple reaction monitoring transition with the lowest signal intensity, wherein step ii) further comprises comparing the quantifier/qualifier ratios of the remaining multiple reaction monitoring transitions of the internal standard with the reference value.
Embodiment 7. The method according to the preceding embodiment, wherein, if the deviation from one of the quantifier/qualifier ratios of the remaining multiple reaction monitoring transitions is within the predefined tolerance range, step iii) comprises determining the measurement result from the multiple reaction monitoring transitions of the analyte and the internal standard of the multiple reaction monitoring channel group corresponding to said quantifier/qualifier ratio.
Embodiment 8. The method according to embodiment 6, wherein step iii) comprises, if the deviations for both quantifier/qualifier ratios of the remaining multiple reaction monitoring transitions are within the predefined tolerance range, determining the measurement result from the analyte and the internal standard using a sum of the remaining multiple reaction monitoring transitions.
Embodiment 9. The method according to any one of the three preceding embodiments, wherein step iii) comprises otherwise rejecting any that deviates by more than the predefined tolerance range from the reference value.
Embodiment 10. The method according to any one of the preceding embodiments, wherein the database comprises at least one information of the group consisting of: an analyte ID, a sample matrix ID, an instrument ID, a method or assay ID, an average quantifier/qualifier ratio of the internal standard.
Embodiment 11. The method according to any one of the preceding embodiments, wherein the mass spectrometry device is operated in a random access mode, wherein samples are randomly and continuously loaded.
Embodiment 12. The method according to any one of the preceding embodiments, wherein the mass spectrometry device is a triple quadrupole mass spectrometry device.
Embodiment 13. The method according to any one of the preceding embodiments, wherein the method is computer-implemented.
Embodiment 14. A system for multiple transition monitoring of at least one analyte in a sample comprising:
   at least one mass spectrometer device configured for measuring multiple reaction monitoring transitions of quantifier and qualifier of both an internal standard and an analyte using staggered-multiple reaction monitoring, wherein the staggered-multiple reaction monitoring comprises at least three multiple reaction monitoring channel groups, wherein one of the multiple reaction monitoring channel groups measure at respective theoretical m/z values of the quantifier and qualifier of both the internal standard and the analyte and the two other multiple reaction monitoring channel groups measure at respective m/z values shifted to higher and lower values by a predefined level;
   at least one database configured for storing at least one reference value;
   at least one processing device configured for comparing at least two quantifier/qualifier ratio of the multiple reaction monitoring transitions of the internal standard with the reference value from the database, the comparison comprises determining a deviation between the quantifier/qualifier ratios and the reference value, wherein the processing device is configured for determining from the analyte and the internal standard measured multiple reaction monitoring transitions a measurement result, if the deviation is within at least one predefined tolerance range, and otherwise for rejecting the measured multiple reaction monitoring transitions.
Embodiment 15. The system for multiple transition monitoring according to the preceding embodiment, wherein the system is configured for performing a method for multiple reaction monitoring according to any one of the preceding method embodiments.
Embodiment 16. A computer program comprising instructions which, when the program is executed by a processing device on a system according to any one of the preceding embodiments referring to a system, cause the system to perform the method according to any one of the preceding embodiments referring to a method.
Embodiment 17. A computer-readable storage medium comprising instructions which, when the instructions are executed by a processing device on a system according to any one of the preceding embodiments referring to a system, cause the system to perform the method according to any one of the preceding embodiments referring to a method.
Embodiment 18. A non-transient computer-readable medium including instructions that, when executed by one or more processors, cause the one or more processors to perform the method according to any one of the preceding embodiments referring to a method.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIG. 1 shows an embodiment of a system according to the present invention;

FIG. 2 shows a flow chart of an embodiment of the method according to the present invention; and

FIGS. 3A and 3B show experimental results.

### DETAILED DESCRIPTION OF THE EMBODIMENTS

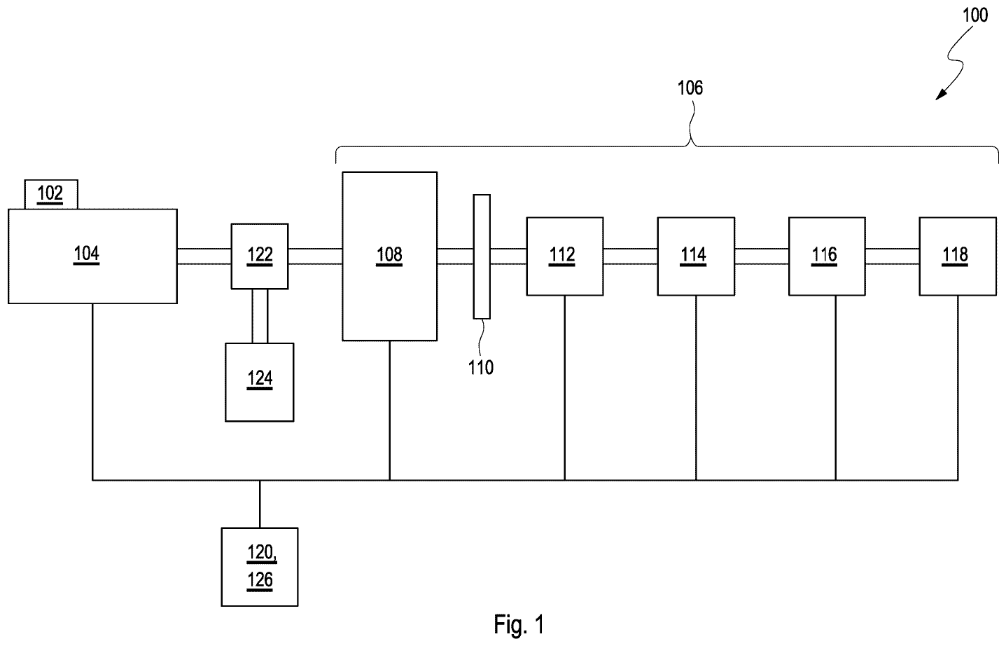

FIG. 1 shows an embodiment of a system 100 according to the present invention. In this embodiment, the system 100 comprises a liquid chromatography-mass spectrometry (LC-MS) device. System 100 may comprise an inlet 102 connected to a liquid chromatography column 104. Column 104 may be coupled to an MS device 106 through an optional valve 122 that is connected to an optional waste reservoir 124. MS device 106 may comprise an ionizer 108, a skimmer 110, quadrupolar stages Q1 112, Q2 114, and Q3 116, and a detector 118. Each of the components can optionally be connected to a processing device 120.

The MS device 106 is configured for measuring multiple reaction monitoring transitions of quantifier and qualifier of both an internal standard and an analyte using staggered-multiple reaction monitoring (S-MRM). The staggered-multiple reaction monitoring comprises at least three multiple reaction monitoring channel groups. One of the multiple reaction monitoring channel groups measure at respective theoretical m/z values of the quantifier and qualifier of both the internal standard and the analyte and the two other multiple reaction monitoring channel groups measure at respective m/z values shifted to higher and lower values by a predefined level. The staggered-multiple reaction monitoring may comprise multiple reaction monitoring using a set of staggered m/z values, e.g. a theoretical m/z value and m/z values shifted to higher and lower values by a predefined level. The predefined level may be specified as half of a maximum expected drift of a mass axis for a relevant m/z range. Additional measurement at other levels may be possible, too.

The staggered-multiple reaction monitoring comprises at least three multiple reaction monitoring channel groups. The multiple reaction monitoring channel group may be or more comprise one or more of MRM transitions measured at Q1 and Q3 using the same m/z value. One of the multiple reaction monitoring channel groups measures at respective theoretical m/z values of the quantifier and qualifier of both the internal standard and the analyte and the two other multiple reaction monitoring channel groups measure at respective m/z values shifted to higher and lower values by a predefined level. For example, the S-MRM may use MS resolution(s) at Q1 and Q3 that are optimized for the targeted analyte for all MRM transitions. A first MRM transition set may be measured comprising of the quantifier and qualifier MRM transitions for both analyte and internal standard at their respective targeted m/z values. In addition, a second MRM transition set may be measured which is shifted to a higher m/z value at Q1 and Q3 and a third MRM transition set may be measured which is shifted to a lower m/z value at Q1 and Q3. Hence, a total of six MRM transitions for the targeted analyte and a total of six MRM transitions for the internal standard may be measured. For example, the method may comprise the following measurements:

| No | Compound | Q1 | Q3 |
|---|---|---|---|
| 1 | Analyte | Target m/z | Target m/z |
| 2 | Analyte | Target m/z + 0.2 Da | Target m/z + 0.2 Da |
| 3 | Analyte | Target m/z − 0.2 Da | Target m/z − 0.2 Da |
| 4 | ISTD | Target m/z | Target m/z |
| 5 | ISTD | Target m/z + 0.2 Da | Target m/z + 0.2 Da |
| 6 | ISTD | Target m/z − 0.2 Da | Target m/z − 0.2 Da |

The processing device 120 may comprise at least one electronic processor. The processing device 120 is configured for comparing at least two quantifier/qualifier ratio of the multiple reaction monitoring transitions of the internal standard with the reference value from a database 126. The comparison comprises determining a deviation between the quantifier/qualifier ratios and the reference value. The processing device 120 is configured for determining from the analyte and the internal standard measured multiple reaction monitoring transitions a measurement result, if the deviation is within at least one predefined tolerance range, and otherwise for rejecting the measured multiple reaction monitoring transitions.

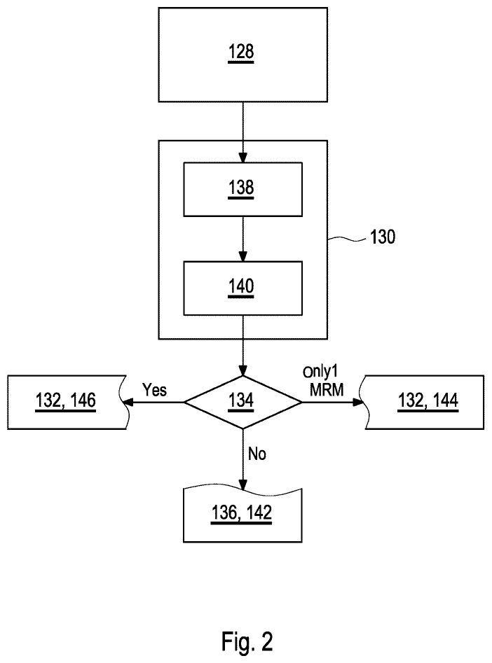

The processing device 120 may comprise at least one database. The processing device 120 may comprise at least one display device. The processing device 120 may comprise at least one communication interface for receiving instructions and data from a user of system 100. With respect to further details, of the processing device 120, reference is made to the description of the method according to the present invention, e.g. as described with respect to FIG. 2.

During operation of system 100, a sample is introduced into inlet 102, e.g., via direct injection. Following introduction, the sample may enters column 104 and is deposited onto the column material (e.g., a resin material). The sample may migrate across the column material as one or more solvents flow across the column material. As the sample collectively migrates, different components of the sample migrate at different rates, and therefore reach the end of the column at different times. Column 104 can optionally be connected to a valve 122 as described above, which can in turn optionally be connected to a waste reservoir 124. During operation of system 100, valve 122 can optionally be activated by the processing device 120 to direct eluent from column 104 to waste reservoir 124, or to MS device 106. Selectively directing only portions of the eluent to MS device 106 can ensure that only components of interest in the sample are measured. The MS device 106 can include a detector connected to processing device 120 that generates an electrical signal when a component of the sample elutes from column 104 and reaches the detector. The processing device 120 may receive the electrical signal, and can determine whether to direct the eluent into waste reservoir 124 or into MS device 106. The processing device 120 may be configured for determining which direction to direct the eluent based on an elapsed time between introduction of the sample at inlet 102, and detection of the component emerging from the downstream end of column 104. The elapsed time can be compared to reference information that includes elution times from known sample components to yield at least a preliminary identification of the component. Based on that preliminary identification, processing device 120 can determine whether the component is of interest (and is therefore directed to MS device 106), or whether the component is not of interest (and is directed to waste reservoir 124). When sample components are not eluting from column 104 (e.g., at time intervals during which only elution solvents emerge from column 104), the eluent can also optionally be directed to waste reservoir 124 rather than to MS device 106.

Various detectors can be positioned between column 104 and MS device 106 either before valve 122, between valve 122 and MS device 106, or between valve 122 and the waste reservoir 124 to facilitate component detection as the sample components are eluted from column 104. Examples of suitable detectors include, but are not limited to, optical detectors such as photodiodes, photocells, spectral detectors, and CCDs, and electrical detectors such as conductivity sensors and resistivity sensors.

Sample components that enter MS device 106 may be received into ionizer 108, where they are ionized to form a population of ions. Ionizer 108 can be implemented as any of a wide variety of different types of ionizers. Examples of suitable ionizers include, but are not limited to, electrospray ionizers, electron ionizers, atmospheric pressure chemical ionizers, thermospray ionizers, inductively coupled plasma ionizers, glow discharge ionizers, and photoionizers. The population of ions generated in ionizer 108 may pass through skimmer 110, which typically includes an aperture of reduced dimension (relative to an exit aperture of ionizer 108), and which reduces the population of ions that are directed into the quadrupole stages of MS device 106. After passing through skimmer 110, the ions may be separated and detected in the remaining portion of MS device 106.

A wide variety of different mass spectrometer configurations can be used to separate, detect, and analyze ions generated from sample components. MS device 106 is one example of such a configuration. However, it should be understood that the calibration methods described herein can be used with many different configurations of MS device 106, and are in no way limited to the configuration shown in FIG. 1.

For example, the MS device 106 may be implemented as a tandem mass spectrometer (e.g., tandem MS/MS), with three quadrupolar stages Q1 112, Q2 114, and Q3 116. In the first quadrupolar stage 112, ions that pass through skimmer 110 are filtered to select ions that fall within a particular range of m/z values for further analysis Ions that fall outside this range of m/z values are blocked, and do not pass through quadrupolar stage 112. Conversely, ions that fall within the desired range of m/z values pass through quadrupolar stage 112 and enter the second quadrupolar stage 114. Quadrupolar stage 112 may comprise four electrodes arranged about a central symmetry axis. To selectively direct only ions with m/z values that fall within a desired range to the second quadrupolar stage 114, processing device 120 may be configured for adjusting the electrical potential(s) applied to the four electrodes. With suitable potentials applied, the four quadrupolar electrodes generate an oscillating radiofrequency (RF) field, which functions to guide ions from one end to another along the quadrupolar stage 112. For a particular RF field, ions within a certain range of m/z values are guided out of an exit aperture of quadrupolar stage 112, and ions of m/z that fall outside the range are rejected (e.g., blocked) within quadrupolar stage 112. A subset of the ions that enter first quadrupolar stage 112 pass through stage 112 and enter the second quadrupolar stage 114. The second quadrupolar stage 114 is implemented as a collision cell in which ions that enter stage 114 are fragmented to form a distribution of ions of relatively smaller molecular mass. This distribution of smaller mass ions, which are derived from the larger mass ions that typically enter stage 114 from stage 112, passes through stage 114 into third quadrupolar stage 116. Within second quadrupolar stage 114, the processing device 120 may apply electrical potentials to one or more electrodes to generate one or more electric fields, establishing a field gradient between the entrance and exit apertures of stage 114. Ions entering from stage 112 are typically accelerated by the field gradient. Atoms or molecules of a neutral gas are introduced into stage 114, and collide with the accelerated ions entering from stage 112, generating (via collisions) the ion fragments that pass through to stage 116. Various gases can be used in the fragmentation process including, but not limited to, hydrogen, nitrogen, and noble gases such as argon. After the distribution of smaller mass ions (referred to herein as the “fragment ions”) enters the third quadrupolar stage 116, the fragment ions are filtered in a manner similar to the filtering that occurs in stage 112. Specifically, stage 116 may comprise four electrodes arranged about a central symmetry axis, and controller 120 adjusts one or more electrical potentials applied to the four electrodes to generate an oscillating RF field within stage 116. The generated field guides a subset of the ion fragments, each having a m/z that falls within a particular range, from one end of stage 116 to the other and to detector 118. Ion fragments with m/z values outside this range are rejected (e.g., blocked) within quadrupolar stage 116. The subset of the ion fragments guided out of third quadrupolar stage 116 and are measured by the detector 118. Specifically, measurement signals corresponding to the fragments are generated by detector 118 and transmitted to processing device 120, which records the intensity of the measurement signals. Detector 118 can incorporate a variety of different detection techniques. In certain embodiments, detector 118 corresponds to an electron multiplier, a Faraday cup, or a microchannel plate detector. In some embodiments, detector 118 is an Orbitrap-based detector. More generally, detector 118 can implement any one or more known ion detection techniques.

FIG. 2 shows a flow chart of an embodiment of the method according to the present invention.

The method comprises the following steps which, as an example, may be performed in the given order. It shall be noted, however, that a different order is also possible. Further, it is also possible to perform one or more of the method steps once or repeatedly. Further, it is possible to perform two or more of the method steps simultaneously or in a timely overlapping fashion. The method may comprise further method steps which are not listed.

The method comprises the following steps:
i) (denoted with reference number 128) measuring, by using the mass spectrometry device 106, multiple reaction monitoring transitions of quantifier and qualifier of both an internal standard and an analyte using staggered-multiple reaction monitoring, wherein the staggered-multiple reaction monitoring comprises at least three multiple reaction monitoring channel groups, wherein one of the multiple reaction monitoring channel groups measure at respective theoretical m/z values of the quantifier and qualifier of both the internal standard and the analyte and the two other multiple reaction monitoring channel groups measure at respective m/z values shifted to higher and lower values by a predefined level;
ii) (denoted with reference number 130) comparing at least two quantifier/qualifier ratios of the multiple reaction monitoring transitions of the internal standard with a reference value from the database 126 by using at least one processing device 120, wherein the comparison comprises determining a deviation between the quantifier/qualifier ratios and the reference value;
iii) (denoted with reference number 132) determining from the analyte and the internal standard measured multiple reaction monitoring transitions a measurement result by using the processing device, if the deviation for at least one of the quantifier/qualifier ratios is within at least one predefined tolerance range (denoted with reference number 134), otherwise rejecting the measured multiple reaction monitoring transition (denoted with reference number 136).

As outlined above, for example, the S-MRM may use MS resolution(s) at Q1 and Q3 that are optimized for the targeted analyte for all MRM transitions. A first MRM transition set may be measured comprising of the quantifier and qualifier MRM transitions for both analyte and internal standard at their respective targeted m/z values. In addition, a second MRM transition set may be measured which is shifted to a higher m/z value at Q1 and Q3 and a third MRM transition set may be measured which is shifted to a lower m/z value at Q1 and Q3. Hence, a total of six MRM transitions for the targeted analyte and a total of six MRM transitions for the internal standard may be measured.

The reference value used in step ii) may be a pre-defined and/or pre-measured quantifier/qualifier ratio of the internal standard at a target m/z. The database 126 may comprise at least one information of the group consisting of: an analyte ID, a sample matrix ID, an instrument ID, a method or assay ID, an average quantifier/qualifier ratio of the internal standard. From one or more of this information the processing device 120 may determine the reference value.

Step ii) may comprise comparing 130 all of the quantifier/qualifier ratio of the multiple reaction monitoring transitions of the internal standard measured in step i) with the reference value.

Additionally or alternatively, in step ii) a selection 138 may be performed. Step ii) may comprise selecting 138 two quantifier/qualifier ratios of the multiple reaction monitoring transitions of the internal standard depending on signal intensities of the multiple reaction monitoring transitions of the internal standard quantifier. For example, step ii) may comprise comparing signal intensities of the three MRM transitions of the internal standard quantifier. The comparison of the signal intensities may be performed by executing a software algorithm. In the case where the mass axis is stable (i.e. minimal or no drift), the multiple reaction monitoring channel group measuring using the respective m/z values for the targeted analyte and ISTD will produce the highest signal intensity. In the case where the mass axis drifts significantly to higher or lower m/z values, one of the other multiple reaction monitoring channel groups will produce the highest signal intensity.

Step ii) may comprise rejecting 136 the multiple reaction monitoring transition with the lowest signal intensity. For example, step ii) may comprise selecting 138 two of three internal standard MRM transitions with highest signal intensity and rejecting 136 the MRM transition with the lowest signal intensity. Thus, the comparison 130 in step ii) may comprise comparing 140 the selected quantifier/qualifier ratios of the remaining multiple reaction monitoring transitions of the internal standard with the reference value.

Depending on the result of the comparison in step ii), in step iii) different actions may be performed. If the deviation for at least one of the quantifier/qualifier ratios is within at least one predefined tolerance range, step iii) comprises determining 132 from the analyte and the internal standard measured multiple reaction monitoring transitions a measurement result by using the processing device 120. The predefined tolerance range may be ±15%, preferably ±10%, more preferably ±5% from the reference value. The determining 132 of the measurement result may be performed by executing a software algorithm. The measurement result may be or may comprise at least one quantitative information, e.g. a value, about the analyte in the sample. The measurement result may be the final patient result. The measurement result may further comprise a quality information about the stability of the mass axis depending on the determined deviation, e.g. a flag.

Otherwise, i.e. in case the deviation for none of the quantifier/qualifier ratios is within the predefined tolerance range, step iii) comprises rejecting 136 the measured multiple reaction monitoring transitions. Step iii) may further comprise flagging 142 the data as outlier. Step iii) may comprise checking the quantifier/qualifier ratio of the two remaining MRM transitions of the internal standard and rejecting any that deviate by more than at least one predefined tolerance range from the reference value.

For example, if the deviation from only one of the quantifier/qualifier ratios of the remaining multiple reaction monitoring transitions is within the predefined tolerance range, step iii) comprises determining 144 the measurement result from the multiple reaction monitoring transitions of the analyte and the internal standard of the multiple reaction monitoring channel group corresponding to said quantifier/qualifier ratio. For example, the final patient result may be calculated by analyte_{MRM}/ISTD_{MRM} using the single MRM transition set of analyte and internal standard of the multiple reaction monitoring channel group fulfilling the condition. Step iii) may comprise rejecting any multiple reaction monitoring channel group that deviates by more than the predefined tolerance range from the reference value.

For example, if the deviations for both quantifier/qualifier ratios of the remaining multiple reaction monitoring transitions are within the predefined tolerance range, step iii) may comprise determining 146 the measurement result from the analyte and the internal standard using a sum of the remaining multiple reaction monitoring transitions. For determining 146 of the measurement result the multiple reaction monitoring transitions of the analyte and the internal standard of the multiple reaction monitoring channel groups corresponding to said quantifier/qualifier ratios fulfilling the condition may be used. For example, the analyte and internal standard transitions of the monitoring channel groups fulfilling the condition may be denoted as FirstAnalyte_{MRM}, SecondAnalyte_{MRM}, FirstISTD_{MRM} and SecondISTD_{MRM} The sum may be determined by

$$\frac{{FirstAnalyte}_{MRM} + {SecondAnalyte}_{MRM}}{{FirstISTD}_{MRM} + {SecondISTD}_{MRM}} .$$

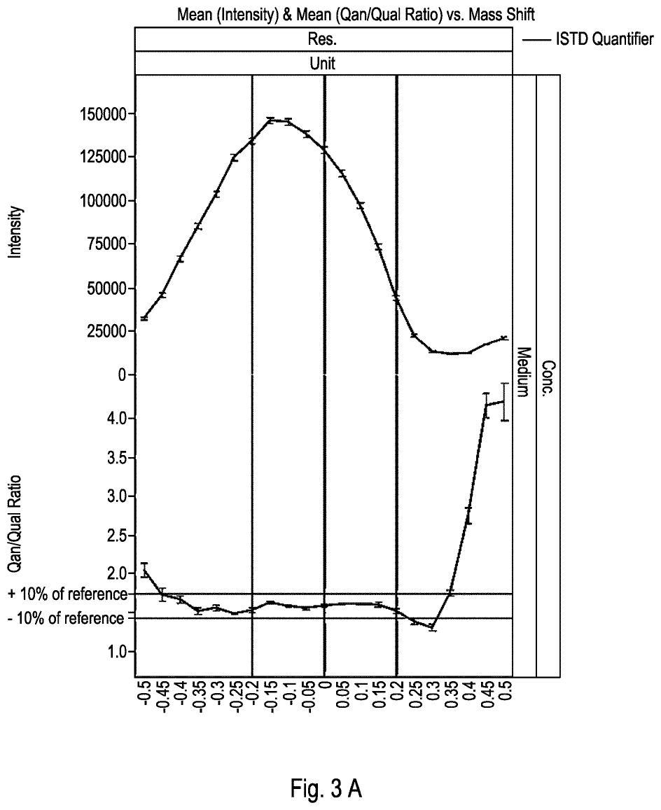

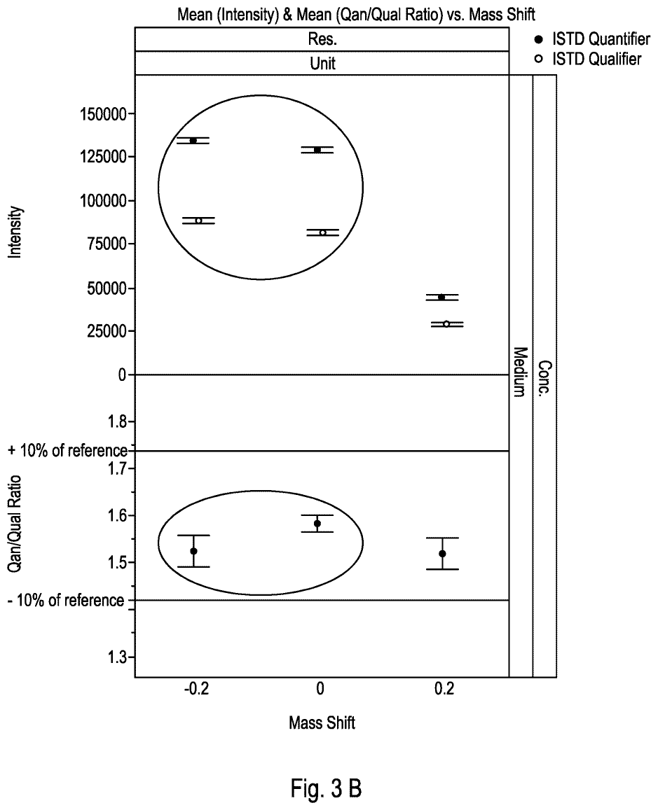

FIGS. 3A and 3B show experimental results.

The experimental setup was as follows. Cyclosporine A (Sigma-Aldrich, 30024), Cyclosporine A-(d10) (Roche, in-house production), Acetonitrile ULC/MS grade (Biosolve, 012041), Milli-Q water (Merck, Advantage A10), Ammonium acetate (Sigma-Aldrich, 73594), LC pump (Agilent 1290 Infinity II), external syringe pump (Harvard Apparatus, PHD Ultra series), T-piece (VWR), ESI-MS/MS (e.g. Sciex TQ 6500+).

A solution containing 100 ng/mL Cyclosporine A (analyte) and 100 ng/mL isotopic-labelled Cyclosporine A-(d10) (ISTD) in 90% acetonitrile (v/v) was infused by an external syringe pump (infusion pump) at a flow rate of 40 μL/min. In parallel, a LC pump was operated at isocratic conditions using 10% of eluent A (15 mM ammonium acetate) and 90% of eluent B (methanol) (v/v). The flow rate of the LC pump was 400 μL/min. Both infusion pump and LC pump were connected via T-piece resulting in a total flow rate of 440 μL/min directed into the ESI-MS/MS.

Data was acquired in positive polarity and MRM mode. The target analyte transition was m/z 1269.875/1184.838 amu. The target ISTD transition was m/z 1229.938/1194.901 amu. Additionally, the target m/z−0.2 amu and target m/z+0.2 amu was measured for both analyte and ISTD resulting in six transitions in total. The measure time of each transition was 40 ms and the total cycle number was 16. Both quadrupoles of the MS/MS instrument were set 0.8 amu resolution. Data analysis was performed based on signal intensity in cps.

In FIG. 3A, upper part, the mean intensity as a function of the mass shift is shown for the internal standard quantifier. In FIG. 3A, lower part, the mean quantifier/qualifier ratio as a function of the mass shift is shown for the internal standard quantifier. The target m/z, target m/z−0.2 amu and target m/z+0.2 amu are shown as vertical solid lines. In addition, in FIG. 3A, lower part, a predefined tolerance range of +10% is depicted, which is used in step iii).

In FIG. 3A several m/z ranging from −0.5 to +0.5 Da of theoretical m/z were measured. However, only three m/z per analyte and ISTD may be used for following data analysis as described with respect to FIGS. 1 and 2 before. These are shown in FIG. 3B. In FIG. 3B, upper part, the mean intensity as a function of the mass shift is shown for the internal standard quantifier for the used three m/z (target m/z, target m/z−0.2 amu and target m/z+0.2 amu). In FIG. 3B, lower part, the mean quantifier/qualifier ratio as a function of the mass shift is shown for the internal standard quantifier. In addition, in FIG. 3B, lower part, a predefined tolerance range of #10% is depicted, which is used in step iii).

FIG. 3B further shows a selection 138 of two quantifier/qualifier ratios of the multiple reaction monitoring transitions of the internal standard depending on signal intensities of the multiple reaction monitoring transitions of the internal standard quantifier. Two of the three ISTD MRMs with highest signal intensity may be selected 138 (the selected ISTD MRMs are highlighted with a circle). The quantifier/qualifier ratio of two selected ISTD MRMs may compared with reference from the database 126, e.g. in this case 1.578. In case the ratio of two selected MRMs is within ±10% compared to the reference, the final patient result may be calculated from analyte and ISTD by using sum of the two 2 MRMs as described above.

### LIST OF REFERENCE NUMBERS

100 system
102 inlet
104 liquid chromatography column
106 MS device
108 ionizer
110 skimmer
112 Q1
114 Q2
116 Q3
118 detector
120 processing device
122 valve
124 waste reservoir
126 database
128 measuring
130 comparing
132 determining
134 deviation within predefined tolerance range?
136 rejecting
138 selection
140 comparing
142 flagging
144 determining measurement result
146 determining measurement result

1. A method for multiple reaction monitoring using a mass spectrometry device, the method comprises:
measuring, by using the mass spectrometry device, multiple reaction monitoring transitions of quantifier and qualifier of both an internal standard and an analyte using staggered-multiple reaction monitoring, wherein the staggered-multiple reaction monitoring comprises at least three multiple reaction monitoring channel groups, wherein one of the multiple reaction monitoring channel groups measure at respective theoretical m/z values of the quantifier and qualifier of both the internal standard and the analyte and the two other multiple reaction monitoring channel groups measure at respective m/z values shifted to higher and lower values by a predefined level;
comparing, for at least two groups, at least two of the quantifier/qualifier ratios of the multiple reaction monitoring transitions of the internal standard with a reference value from a database by using at least one processing device, wherein the comparison comprises determining a deviation between the quantifier/qualifier ratios and the reference value;
determining from the analyte and the internal standard measured multiple reaction monitoring transitions a measurement result by using the processing device, if the deviation for at least one of the quantifier/qualifier ratios is within at least one predefined tolerance range, otherwise rejecting the measured multiple reaction monitoring transitions.

2. The method according to claim 1, wherein the predefined level is specified as half of a maximum expected drift of a mass axis for a relevant m/z range.

3. The method according to claim 1, wherein the at least one predefined tolerance range is ±15% from the reference value.

4. The method according to claim 1, wherein comparing the at least two of the quantifier/qualifier ratios comprises selecting two quantifier/qualifier ratios of the multiple reaction monitoring transitions of the internal standard depending on signal intensities of the multiple reaction monitoring transitions of the internal standard quantifier.

5. The method according to claim 4, wherein comparing the at least two of the quantifier/qualifier ratios comprises comparing the selected quantifier/qualifier ratios of the multiple reaction monitoring transitions of the internal standard with the reference value.

6. The method according to claim 4, wherein comparing the at least two of the quantifier/qualifier ratios comprises:
comparing signal intensities of the multiple reaction monitoring transitions of the internal standard quantifier;
rejecting the multiple reaction monitoring transition with the lowest signal intensity; and
comparing the quantifier/qualifier ratios of the remaining multiple reaction monitoring transitions of the internal standard with the reference value.

7. The method according to claim 6, wherein, if the deviation from one of the quantifier/qualifier ratios of the remaining multiple reaction monitoring transitions is within the predefined tolerance range, determining the measurement result comprises determining the measurement result from the multiple reaction monitoring transitions of the analyte and the internal standard of the multiple reaction monitoring channel group corresponding to said quantifier/qualifier ratio.

8. The method according to claim 6, wherein determining the measurement result comprises, if the deviations for both quantifier/qualifier ratios of the remaining multiple reaction monitoring transitions are within the predefined tolerance range, determining the measurement result from the analyte and the internal standard using a sum of the remaining multiple reaction monitoring transitions.

9. The method according to claim 6, wherein determining the measurement result comprises otherwise rejecting any that deviates by more than the predefined tolerance range from the reference value.

10. (canceled)

11. A system for multiple transition monitoring of at least one analyte in a sample, the system comprising:
at least one mass spectrometer device configured for measuring multiple reaction monitoring transitions of quantifier and qualifier of both an internal standard and an analyte using staggered-multiple reaction monitoring, wherein the staggered-multiple reaction monitoring comprises at least three multiple reaction monitoring channel groups, wherein one of the multiple reaction monitoring channel groups measure at respective theoretical m/z values of the quantifier and qualifier of both the internal standard and the analyte and the two other multiple reaction monitoring channel groups measure at respective m/z values shifted to higher and lower values by a predefined level;
at least one database configured for storing at least one reference value;
at least one processing device configured for comparing, for at least two groups, at least two quantifier/qualifier ratio of the multiple reaction monitoring transitions of the internal standard with the reference value from the database, the comparison comprising determining a deviation between the quantifier/qualifier ratios and the reference value, wherein the processing device is configured for determining from the analyte and the internal standard measured multiple reaction monitoring transitions a measurement result, if the deviation is within at least one predefined tolerance range, and otherwise for rejecting the measured multiple reaction monitoring transitions.

12. (canceled)

13. (canceled)

14. (canceled)

15. The method according to claim 1, wherein the at least one predefined tolerance range is ±10% from the reference value.

16. The method according to claim 1, wherein the at least one predefined tolerance range is ±5% from the reference value.

17. At least one non-transitory computer-readable storage medium comprising a plurality of instructions stored thereon that, in response to execution by one or more processors, causes the one or more processors to:
measure, by using a mass spectrometry device, multiple reaction monitoring transitions of quantifier and qualifier of both an internal standard and an analyte using staggered-multiple reaction monitoring, wherein the staggered-multiple reaction monitoring comprises at least three multiple reaction monitoring channel groups, wherein one of the multiple reaction monitoring channel groups measure at respective theoretical m/z values of the quantifier and qualifier of both the internal standard and the analyte and the two other multiple reaction monitoring channel groups measure at respective m/z values shifted to higher and lower values by a predefined level;
compare, for at least two groups, at least two of the quantifier/qualifier ratios of the multiple reaction monitoring transitions of the internal standard with a reference value from a database, wherein the comparison comprises determining a deviation between the quantifier/qualifier ratios and the reference value;
determine from the analyte and the internal standard measured multiple reaction monitoring transitions a measurement result, if the deviation for at least one of the quantifier/qualifier ratios is within at least one predefined tolerance range, otherwise rejecting the measured multiple reaction monitoring transitions.

18. The at least one non-transitory computer-readable storage medium according to claim 17, wherein the at least one predefined tolerance range is ±15 from the reference value.

19. The at least one non-transitory computer-readable storage medium according to claim 17, wherein to compare the at least two of the quantifier/qualifier ratios comprises to select two quantifier/qualifier ratios of the multiple reaction monitoring transitions of the internal standard depending on signal intensities of the multiple reaction monitoring transitions of the internal standard quantifier.

20. The at least one non-transitory computer-readable storage medium according to claim 19, wherein to compare the at least two of the quantifier/qualifier ratios comprises to compare the selected quantifier/qualifier ratios of the multiple reaction monitoring transitions of the internal standard with the reference value.

21. The at least one non-transitory computer-readable storage medium according to claim 19, wherein to compare the at least two of the quantifier/qualifier ratios comprises to:
compare signal intensities of the multiple reaction monitoring transitions of the internal standard quantifier;
reject the multiple reaction monitoring transition with the lowest signal intensity; and
compare the quantifier/qualifier ratios of the remaining multiple reaction monitoring transitions of the internal standard with the reference value.

22. The at least one non-transitory computer-readable storage medium according to claim 21, wherein, if the deviation from one of the quantifier/qualifier ratios of the remaining multiple reaction monitoring transitions is within the predefined tolerance range, to determine the measurement result comprises to determine the measurement result from the multiple reaction monitoring transitions of the analyte and the internal standard of the multiple reaction monitoring channel group corresponding to said quantifier/qualifier ratio.

23. The at least one non-transitory computer-readable storage medium according to claim 21, wherein to determine the measurement result comprises, if the deviations for both quantifier/qualifier ratios of the remaining multiple reaction monitoring transitions are within the predefined tolerance range, to determine the measurement result from the analyte and the internal standard using a sum of the remaining multiple reaction monitoring transitions.

24. The at least one non-transitory computer-readable storage medium according to claim 21, wherein to determine the measurement result comprises to otherwise reject any that deviates by more than the predefined tolerance range from the reference value.
